(19) United States
(12) Patent Application Publication
(10) Pub. No.: US 2002/0069222 A1
(43) Pub. Date: Jun. 6, 2002

(54) System and method for placing active tags in HTML document

(75) Inventor: Mark J. McNeely, Weston, FL (US)

Correspondence Address: ROBERT C. KAIN, JR., 750 SOUTHEAST THIRD AVENUE, SUITE 100, FT LAUDERDALE, FL, 333161153

(73) Assignee: Wiznet, Inc.

(21) Appl. No.: 09/728,504

(22) Filed: Dec. 1, 2000

(51) Int. Cl. G06F 17/24

(52) U.S. Cl. 707/513

(57) ABSTRACT

The method and the information processing system dynamically creates an HTML document with at least one embedded hyperlink code therein. The HTML document is based upon a source document provided by a manufacturer or a supplier of services. Typically, the system and the method is operable in a client-server computer environment. A database is provided on the server computer system which database associates location data of a plurality of data strings in the source document with hyperlink addresses. The location data in the database maps at least one predetermined data string in the source document. An HTML document, based upon the source document, is published with an image tag on, in or near the predetermined data string. As an example, the string may be a “part number” or a string of words “SONY PLAYSTATION II.”. The published HTML document has an image tag on, at or near the part number and a map attribute command which supplies or generates an HTML location data unique to the image tag location in the HTML document when the browser calls the server's common gateway interface (CGI). The image tag URL points to the database on the server. The server, via the database provides a corresponding hyperlink address, associated with the unique location data correlated to the HTML location data, to the browser on the client computer system. The method and the system then publishes and embeds in the original or initial HTML document at, on or near the predetermined data string or part number an active hyperlink tag (an embedded code) with the corresponding hyperlink address obtained from the database.

The present invention relates to a method and an information processing system for placing active tags in a hypertext mark-up language (HTML)document in real time or in a dynamic manner.

### BACKGROUND OF THE INVENTION

In the 1990s, growth of Internet based information systems was generally based upon the continually decreasing price of computer equipment and the relative ease of creating or programming hypertext mark-up language (HTML) documents. HTML documents are viewable on the Internet with a variety of browser computer programs. The HTML document is relatively easily prepared because substantial portions of the document can be obtained from textual documents produced by common word processing programs (WORD PERFECT from Corel, WORD from Microsoft, etc.), and a relatively small set of programming instructions that can be embedded or inserted into the word processed or textual document. Thereafter, the HTML document can be published or released or posted on the Internet such that any person operating a client computer (in a server-client computer environment), while pointing his or her browser at the URL (Uniform Research Locator which is an address on the Internet) associated with the HTML document, can view the HTML page or document published on the Internet by the server computer system. As used herein, the term “HTML document” refers to any document published or capable of being published on the Internet, a wide area network (WAN) or a local area network (LAN) and may include documents created with XHTML, XML, SGMG (extensible mark-up language or standard generalized mark-up language).

However, a large number of companies have developed and currently utilize catalogs showing a large number of products and services offered to other business and the public in general. In addition to these general catalogs, these companies have developed or created detailed catalog sheets, files or folders describing details (such as product specifications or specs) of particular products or services, and price sheets, files or documents listing or posting the current price of each product and service. The price sheets have a tendency to be modified more frequently than the specific detailed specification of the product or service. Further, the general product/service catalog is typically modified more often than the specific product/service specification document, file or description for each particular product or service. In other words, the price sheet may be changed four (4) times a year (quarterly) and the general product catalog may be modified annually. However, once a detailed product specification or detailed service specification is created, approved and subsequently revised based upon customer feedback after use of the product, that specific detailed specification is not typically modified. The detailed specification will be modified after a significant revision of the product or service. Hence, it is common for businesses to manufacture an item or develop a service package, summarize that product or service in a general catalog, publish a detailed product or service specification and present that detailed specification to the customer upon request or upon delivery of the product or service. The general catalog and the price sheet are provided to customers as general sales tools. The specific or detailed product specification or detailed service specification is presented upon request or shortly before or shortly after the customer purchases the product or service.

At the present time, a significant number of companies utilize both print materials (hard copy) and electronic versions (e.g., CD-ROM) of those print materials to advertise or sell their products and services. However, there is a need in the industry to be able to quickly change both the print version (hard copy) and the electronic version of the catalog published on the Internet as an HTML document. Due to the moderately frequent change of the price list and the general product catalog, there is a need to create an HTML document or documents which can be quickly compiled and subsequently modified or updated in real time or dynamically without engaging the services of one or more computer programers to revise by hand the current “authorized” product and service general catalog, the current price list and link the general catalog and the price list to the detailed product specifications. The same issues arise with respect to mass market retailers (for example, K-MART, WALMART, SEARS, etc.) in that those mass market retailers publish print versions of advertising catalogs. As an example, a mass market retailer may publish with the Sunday newspaper a 5-20 page mini catalog or brochure to advertise particular products in its retail store outlets in the geographic territory established by the distribution of the newspaper. These weekly “mini” product catalogs are known to stimulate sales in the regional retail outlets. Further, it is well known that these “mini” catalogs change weekly and are published based upon seasonal and monthly sales trends or histories of purchasing consumers in the regional area of distribution of the newspaper. It would be beneficial to enable these mass market retailers to electronically publish on the Internet in HTML document which is the same or substantially identical to the “mini” sales catalog without engaging the services of one or more computer programers to (a) copy the text of the source document, that is, the mini catalog into an HTML formatted document; (b) create an HTML document with header and body elements and embedding hyperlink tags therein; and (c) create a new price list and a list of regional stores unique to the user-consumer's geographic location each week or each publication cycle.

The present invention solves these and other problems as described hereinafter.

### OBJECTS OF THE INVENTION

It is an object of the present invention to provide a method and a system for placing active tags in an HTML document dynamically or in real time.

It is a further object of the present invention to enable a quick conversion of a source document (a document with a large amount of textual and graphic items, e.g., a catalog) into an HTML document, identify potential “active areas” in the textual document and provide a computerized method and an information processing system which dynamically creates an HTML document with active hyperlink tags in the published HTML document linking product name or part number active tags in the HTML document to detailed specifications and, at other locations based upon the active tag location of the source document, to a price list.

It is an additional object of the present invention to create these HTML documents with active hyperlink tags in real time, that is, as the browser on the client computer system essentially displays the HTML document.

It is another object of the present invention to provide a method and a system whereby the URL in the active tags can be modified in real time by revising a spreadsheet or a database or a file on the server computer system without altering the initially published HTML document (as explained later, the initial HTML document is modified dynamically or in real time based upon the content of the database and the listed URL data in the database or spreadsheet or file maintained on the server computer system).

### SUMMARY OF THE INVENTION

The method and the information processing system dynamically creates an HTML document with at least one embedded hyperlink code therein. The HTML document is based upon a source document provided by a manufacturer or a supplier of services, sometimes herein identified as “a vendor.” Typically, the system and the method is operable on and in a client-server computer environment which includes at least one server computer and at least one client computer coupled together via a telecommunications network (e.g., the Internet). A database is provided on the server computer system which database associates location data of a plurality of data strings in the source document with hyperlink addresses. The location data in the database maps at least one predetermined data string in the source document. An HTML document, based upon the source document, is published with an image tag on, in or near the predetermined data string. As an example, the predetermined data string may be a “part number” (e.g. Part 001) for a unique part or product manufactured and/or sold by the vendor or a string of words “SONY PLAYSTATION II.”. Alternatively, the term “part number” could refer to a service provided by a service provider or service vendor. For ease of explanation, in this brief summary of the invention, reference will be made to “a part number” as the predetermined data string. The published HTML document has an image tag on, at or near the part number and the image tag includes a map attribute or command which supplies or generates an HTML location data unique to the image tag location in the HTML document when the browser, which received the initial HTML document, calls the server's common gateway interface (CGI) and sends the image tag URL and the HTML location data to the server. The image tag URL points to the database on the server. Hence, the browser software points to the database and sends HTML location data to the CGI on the server. The HTML location data is unique to the image tag location in the published HTML document. The server, via the database, provides a corresponding hyperlink address, associated with the stored location data and correlated to the HTML location data, to the browser on the client computer system. The method and the system then publishes and embeds in the original or initial HTML document at, on or near the predetermined data string or part number an active hyperlink tag (an embedded code) with the corresponding hyperlink address obtained from the database. In this manner, predetermined data strings (part numbers) initially located in a published HTML document can be modified to an active area or element by embedding a hyperlink address in the published HTML document in real time or dynamically after the initial publication of the HTML document. Since the activation of the image tag by the browser occurs substantially instantaneously (although subsequent to the initial publication of the HTML document) and without operator involvement, the final version of the published HTML document includes hyperlink tag and a color change inside the image or data object for the predetermined data string or part number pointing to another URL address. The download of the hyperlink address from the database is automatic, i.e., without operator intervention. In this manner, a vendor can change the price list by publishing a new price list with a new URL, modify the database such that when the part number appears in the general catalog or the detailed specific catalog, the part number becomes active hyperlink tag pointing to the URL of the updated price list. This is just one example of the method and the system disclosed and claimed herein.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 diagrammatically illustrates a system diagram (showing a client-server computer system) and a data flow diagram diagrammatically illustrating the major processes, inputs and outputs of the method and the system flow in accordance with the principles of the present invention.

FIG. 2 diagrammatically illustrates the dynamically created HTML document with active tags pointing to different hyperlinked documents or files.

FIGS. 3A-3F diagrammatically illustrate an HTML catalog document with dynamically created active tags, and detailed HTML documents linked to those active tags and original HTML catalog document.

### DETAILED DESCRIPTION OF THE PREFERRED EMBODIMENTS

The present invention relates to a system and a method for placement of active tags in an HTML document wherein the tags are embedded in the HTML document in real time or dynamically.

It is important to know that the embodiments described herein are only examples of the many advantageous uses of the innovative teachings disclosed herein. In general, statements made in the specification of the present application do not necessarily limit any of the various claimed inventions. For example, the system may be used by a parts manufacturer as explained herein or a book publisher seeking to hyperlink the entries in a table of contents to other portions of the book (in the Table, “section 1.1” becomes a hyperlink tag to the body of the text at “section 1.1;” figures are hyperlinked to image files; etc.). Moreover, some statements may applied to some inventive features but not to others. In general, unless otherwise indicated, singular elements may be in the plural and vice versa with no lost of generality. In the drawings, like numerals referred to like parts, processes or items throughout the several figures.

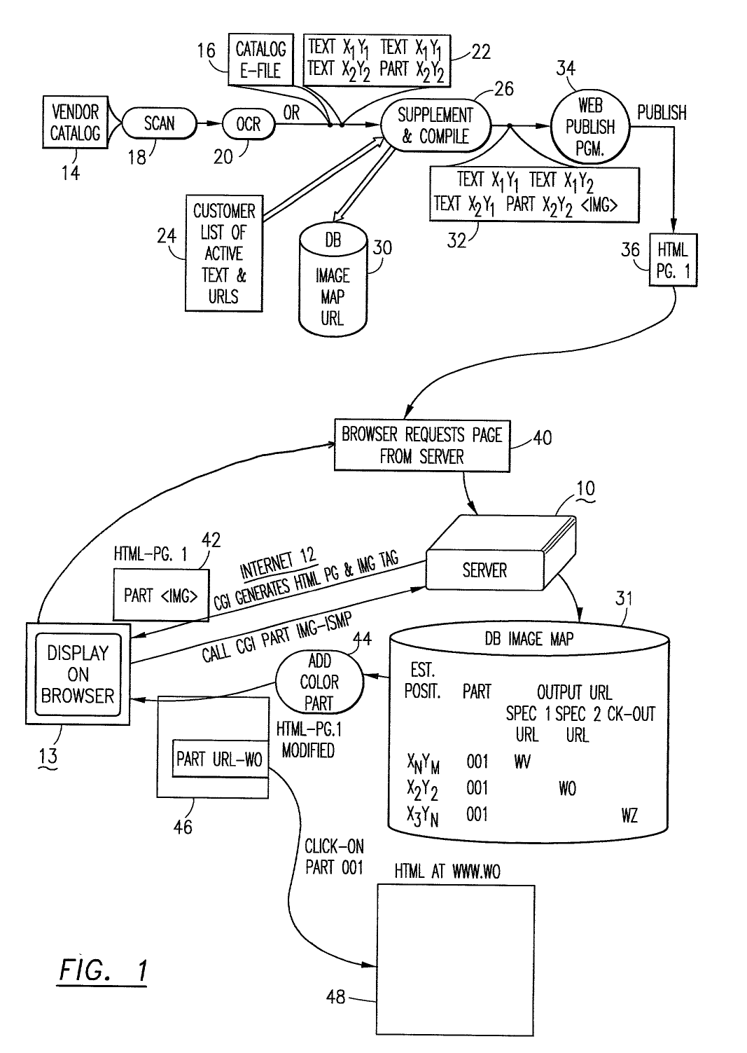

FIG. 1 diagrammatically illustrates both the client-server computer system environment and, more importantly, the primary processes and steps or routines embodying the present invention.

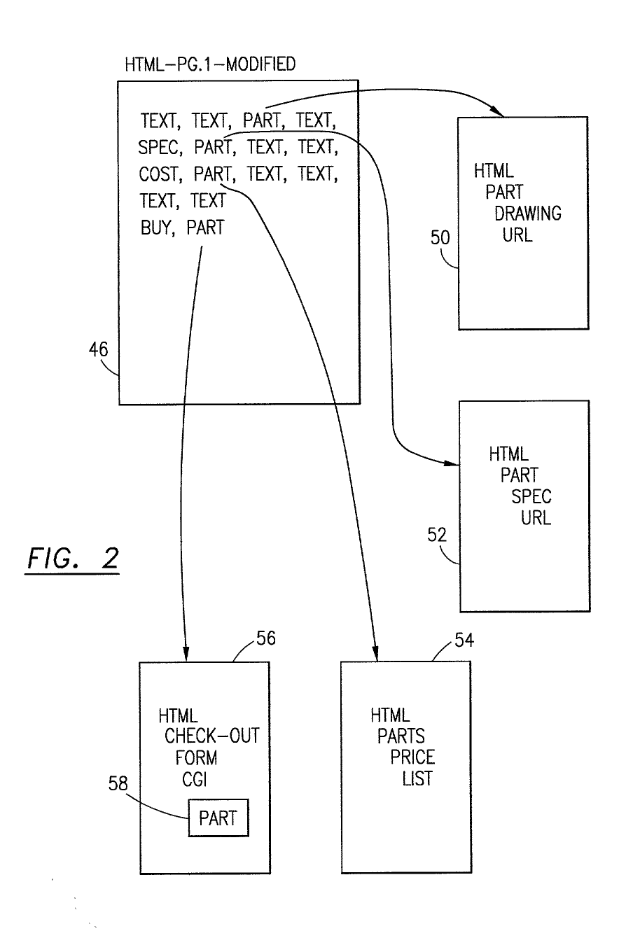

An administrator, sometimes called a system administrator or system operator, maintains server 10. Server 10 is connected to a telecommunications network which, in the illustrated example of the invention in FIG. 1, is Internet 12. A plurality of client computer systems, one of which is client computer system 13, is also coupled to the telecommunications network. Particularly, client computer system 13 is illustrated as a display by the browser program operating on the client computer system. It should be noted that Internet 10 or the telecommunications network may be a wide area network WAN or a local area network LAN or any type of communications system or network linking a primary computer such as a server computer system 10 and a plurality of client computer systems such as client computer system 13. Further, persons of ordinary skill in the art will recognize that server 10 may represent a plurality of servers. This is described later in conjunction with FIG. 2.

FIG. 1 also diagrammatically illustrates data flow and process flow in accordance with the principles of the present invention. A source document representing a textual document may be presented to the system administrator or operator of server 10 in hard copy or may be electronically presented. Although the invention can be utilized in conjunction with any type of source document, whether that source document is an advertising leaflet or mini catalog by a mass merchandise retailer or a parts catalog by a major manufacturer selling parts and components to other businesses or a service provider providing a wide variety of services to the either businesses or consumers, for ease of explanation, a catalog listing parts (i.e., part numbers) is discussed herein. During the description of the present invention herein, reference is made to a vendor catalog 14. However, that vendor catalog can be any type of textual document. Further, in order to explain or convey the concepts of the present invention, reference will be made to a “part number” in the vendor catalog. The “part number” represents a predetermined data string which is preselected by the vendor as being a target or a selected item which should be made an active tag with a hyperlink URL pointer to another document (or to an embedded hyperlink target in the same document, e.g., see the HTML programming NAME function). The following Abbreviations Table provides some further explanation of the terms and words and phrases used herein.

### Abbreviations

IMG Generally an in-line image HTML element; exemplary command SCR=image-URL. Sometimes includes a mapping attribute (e.g., IMG-SCR=image-URL-ISMAP) wherein the browser requests the image at an image-URL address on a server and sends, to the server, the mouse click or HTML location coordinates on the browser's display or screen, or displayed document.

HTML Hyper text mark-up language. Sometimes may include XHTML, XML, SGML or other program languages designed to operate in a client-server environment specifically, but not necessarily exclusively, on the Internet.

OCR Optical character reader process.

PGM Program, process or routine.

Text Any alphabetic, numeric, symbol or other character or character string or combination deemed by the vendor not to be subject to a dynamic hyperlink or active tag. A Text may also be an image.

Part Any Text (see above) which is determined to be an active area per the vendor's request. The “Part” is sometimes referred to as a data string.

Part No. One of several distinct Parts, e.g., Part 001; Part 001.01; Part 002. These different Part numbers are dynamically converted into active hyperlink Text areas (hyperlink tags) on the browser-displayed document. The embedded hyperlink may be different for the same Part No. dependent upon the image IMG location in the document or on the display.

URL Uniform Resource Locator or other client-server locator command or indicator or address.

Text xₙyₙ Any Text (see above) with associated location data. (As a gross example, the Text word “happy” on page 1, paragraph 3, word 3). XₙYₙ Maybe spatial location data of the Text on the HTML page. In the figures, Text xₙyₙ is diagrammatically shown as Text x₁, y₁ to distinguish it from Text x₁y₂ at a different location.

CGI Common Gateway Interface. A program or routine operative on the server.

The system and method begins by utilizing a source document provided by a vendor. A vendor may supply a hard copy (printed version) of a source document as vendor catalog 14 in FIG. 1 or may supply an electronic copy of that source document as shown as source document 16. If the source document is originally presented in print form, the document is scanned in step 18 and the scanned document is processed with an OCR or optical character reader program in step 20. The output of the OCR step 20 or the input of an electronic file from the vendor as source document 16 results in an electronic document diagrammatically illustrated as document 22. If the vendor provides an electronic source document 16, that document may be provided in a format supported by QUARK EXPRESS or ADOBE PDF or Microsoft WORD or other common electronic formats. Whether the document is obtained through scanning step 18 and OCR step 20 or is provided electronically as an electronic e-file 16, the document basically includes various words, letters and numbers (identified as Text) and each letter, word, number or image is further identified in the document with location data x₁y₁. Accordingly, Text x₁y₁ is located at different position in the source document as compared with Text x₁y₂. As stated in the Abbreviations Table, the term “Text” refers to any single number, letter or combination of letters or phrases which are not designated by the vendor as having a overriding importance in the source document. In contrast, the designated or important word, letter, phrase or alphanumeric string, called a predetermined data string, is identified as a “Part” in the figures and in this description. Part has been previously identified as being an important hyperlink data point by the vendor. As further explanation, if a 200 page general catalog showing and providing brief descriptions for 1000 parts is processed through the present system, and if the vendor wanted to provide a hyperlink for each of the 1000 part numbers to detailed part specification sheets (representing an additional 1000 electronic documents), the programing time to (a) identify each of the 1000 occurrences of part numbers and (b) insert the HTML active tag and the associated URL to each unique HTML detailed part specification document or page is an enormous undertaking. An added degree of complexity occurs when each of the 1000 parts is identified, for example, three times in the 200 page catalog. Hence, there are 3000 instances of hyperlink tags which must be inserted into the 200 page general catalog. A further degree of complexity is added when the vendor wants to link the last occurrence of each of the 1000 part numbers in the 200 page general catalog to a price list (i.e., another published HTML document). Hence, the physical location of the part number on each of the 200 pages of the general catalog must correlated to a unique URL linking the HTML general catalog to each of the 1000 detailed product specification pages and linking the last occurrence of each of the 1000 part numbers to the price list URL for the catalog.

In order to determine and identify which data strings in a textual document are critical or should be converted into active hyperlink tags, the customer supplies the system with an electronic file in step 24 listing the part numbers (the predetermined data strings) and the appropriate hyperlink or URLs to other HTML documents as well as a set of rules for establishing what occurrence of the predetermined data string or part number in the 200 page general catalog should be linked to a particular URL or sub-document. Internal hyperlinking within the same document is also contemplated by the present invention. This is done with the NAME tag or command. The following Table describes one methodology of automatically assigning certain URLs or hyperlinks to certain part numbers.

### EXAMPLE

### Process Table: Compile Database

(1) All part nos. on pages 1-20 link to detail specification unique to each part no. (part 001—spec URL part 001; part 002—spec URL part 002).

(2) All part nos. on page 21 link to price URL page.

(3) Part no. 003 on all pages link to—new spec URL part 003.

In step 26, the process searches the source document 22 for the predetermined data string such as a Part No. and inserts an image tag URL which points to a database identified herein as database DB Image Map 31 preferably maintained on server 10. A search and replace routine may be utilized. The following Command Example A shows an exemplary image tag having an image tag URL. In the example, the “image-URL” refers to the pointer to or address for the database DB Image Map file 31. The term “database” refers to a common database, a flat file list or array, a spread sheet or other ordered list or array of data associating on a piece of data to another.

### Command Example A

[disable]<[disable]IMG-SRC=image-URL-ISMAP>

The image tag embedded or placed into the modified source document 22 at, on or near Part No. x₂y₂, is an image tag which generates, upon initial publication of the HTML document, not only a hyperlink pointer to database DB Image Map 31 but also HTML location data unique to the image tag location in the published HTML document. This image tag is sometimes identified as an image map or active image map ISMAP attribute for the IMG element or tag in the HTML document. An image tag with a map attribute is utilized on, in or at the location of part x₂y₂ in the initial HTML document which is based upon source document 22. Hence, process 26 supplements the source document 22. Process 26 may be incorporated into a web publishing program.

Process 26 also compiles a portion of or substantially all of Database Image Map URL 30. This database is linked or built to establish the Database Image Map 31. Database 30 associates location data of a plurality of data strings in the source document 14, 16. Further, Database Image Map 31 associates hyperlink addresses or URLs wv, wo, wz with the predetermined data string and the location data. In other words, for Part 001 at position xₘyₘ, the hyperlink URL address is wv. For Part number 001 at position location x₂y₂, in source document 14, 16, the URL hyperlink is wo. For Part number 001 at position x₃yₙ, the URL shifts the user on client computer system 13 to a checkout routine at hyperlink address wz. Since the location Part No. on the source document 14, 16 may not precisely match the HTML document location, a CGI program adding a position estimation factor (e.g. +/−10%) may be utilized in conjunction with the Database 31.

The output of supplement and compile step 26 is the Database Image Map 31 and the partially formatted HTML document 32. As shown in FIG. 1, the predetermined data string part at position x₂y₂ includes an image tag IMG. This image tag, as discussed above, includes the map attribute. Sometimes the map attribute is identified as an ISMAP attribute.

Process step 34 involves converting the balance of source document 14, 16 into an HTML document. For example, headers will be added to the document to generate an HTML document and certain attributes and image handling and format instructions may be added. The output of web publishing program process 34 is an HTML document 36.

Step 40 recognizes that the browser program on client computer system 13 requests an HTML page at a unique URL from server 10. Server 10 then generates or publishes the HTML document as shown as HTML document 42 “HTML-PG. 1.” The published HTML document includes the predetermined data string Part with an image tag IMG which includes a map attribute. HTML document 42 is published by server 10 and is displayed in published form via the browser program on client computer system 13. The display occurs based upon a CGI call to the browser. See the legend “CGI [call] generates HTML page [from server] with image tag IMG.” When the browser program on client computer system 13 displays the published HTML document, the browser automatically identifies the image tag in the document. The browser automatically generates a call or a request to a common gateway interface CGI on the server identifying the URL from the image tag. The URL for the image tag points to the Database Image Map 31. Further, the image tag also causes the client computer system 13 to generate pixel coordinates of the active IMG tag in the initially published HTML document. These pixel coordinates represent image tag location data in the HTML document. Accordingly, the CGI call from the client computer system 13 (and particularly the browser) points to the Database Image Map 31 and also provides HTML location data (pixel coordinates) identifying where in the HTML document the image Part No. tag appears. Server 10, using CGI, locates Database Image Map 31, locates the Part No. and the HTML location for that Part No. and generates an output representing a URL or Internet address for that Part No. at the document location. The Database Image Map 31 may be located on a different server than the server publishing HTML document 42. In step 44 in a preferred embodiment, server 10 adds a color attribute to the displayed predetermined data string or Part No. The modified HTML page 1 is shown as HTML page 46 wherein the Part No. is highlighted, bolded or in different color, and includes an active hyperlink tag on, at or near the Part No. identifying the Part No. URL or hyperlink destination wo. This corresponds to Part No. location x₂y₂ in database 31. The modified HTML page 46 is displayed on client computer system 13 via the browser software.

In one sense, the HTML page is published twice. In another sense, the Text portion of the HTML page is published and then an image map is generated by to the server 10 and subsequently an “active area” HTML page or map is overlaid or displayed concurrently on the Text version of the Text HTML page. In any event, the Part No. is now distinctly visually identified to the user and is also an active tag with a corresponding hyperlink address embedded therein. Conceptually, page or document 46 is either a modified HTML document 42 with added hyperlinks or an image map with active tags as HTML document 46 is published or overlaid onto HTML document 42. The term “embed” is meant to cover both concepts. The end result is the same, that is, active hypelink tags are at, on or near Part No. If the user selects that Part No. at x₂y₂ and clicks on that Part No., the user's browser is then pointed to HTML document 48 at URL wo.

The terms embedded, overlaid or underlaid are meant to encompass similar concepts. Those concepts being that the part number at that general location xₙyₙ the source document is first published as an HTML document and subsequently server 10 utilizing the image tag and map attribute modifies the initial HTML document and inserts an hyperlink tag and unique URL at that location in the initially published HTML document. The resulting HTML document displayed by the client's browser, includes at least one, and probably many active tags to additional HTML documents. These active tags are created in real time or dynamically without operator intervention.

It should be noted that the active tag inserted in HTML modified document 46 may reference another part of the same HTML document. For example, if the original source document was 200 pages, the initial HTML document 42 is approximately 200 pages. The modified HTML document 46 would also be approximately 200 pages. However, if a part number was generally described in the introduction of the 200 page document and then was more specifically described at, for example, page 96, the hyperlink tag from the first occurrence of that part number in the introduction may be linked to the second occurrence of the part number at page 96. The following Command Example B Table lists some types of active hyperlink tags that may be inserted into HTML modified document 46.

### Command Example B

[disable]<[disable] A—HREF=URL Part> Part </A>

[disable]<[disable] A—Name=“identifier”> Part </A>

[disable]<[disable] A—HREF=“#identifier”> Part </A>

According to established HTML language, an image tag, that is, an in line image element, cannot be used to include another HTML text within a given document. The present invention overcomes this programing limitation by utilizing the map attribute for the image tag (IMG-SRC=image-URL-ISMAP) and republishing the HTML document as HTML modified document 46.

FIG. 2 diagrammatically illustrates an HTML modified document 46. In this document, the first line of the document shows that the predetermined data string or part is linked to an HTML part drawing document 50 at Part-Drawing-URL. Document 50 may be on a different server. In the second line of the modified HTML document 46, the part is linked to a detailed specification HTML document 52. In the third line of modified HTML document 46, the part is associated with the cost and is linked to an HTML parts price list document 54. In the last line of HTML modified document 46, the part is linked to an HTML checkout or purchase transaction form which calls up another CGI on server 10 or another server and places the part number in a “form” element on HTML document 58. The “form” can be used as part of a purchase or “check-out” routine enabling the user to buy the part. FIG. 2 shows an example wherein the same part number at four (4) different physical locations in the HTML modified document 46 (which is originally based on source document 14, 16), has hyperlink pointers to four different HTML documents which show different aspects of the same part. These embedded active tags with hyperlink addresses enable the vendor to quickly link various somewhat independent HTML documents to the master general catalog (HTML document 46). Since the price list HTML document 54 changes more frequently than, for example, the HTML part drawing 50, the vendor can easily revise the parts price list 54 and change the URL for that price list simply by changing Database Image Map 31. Revision of the general catalog is not necessary.

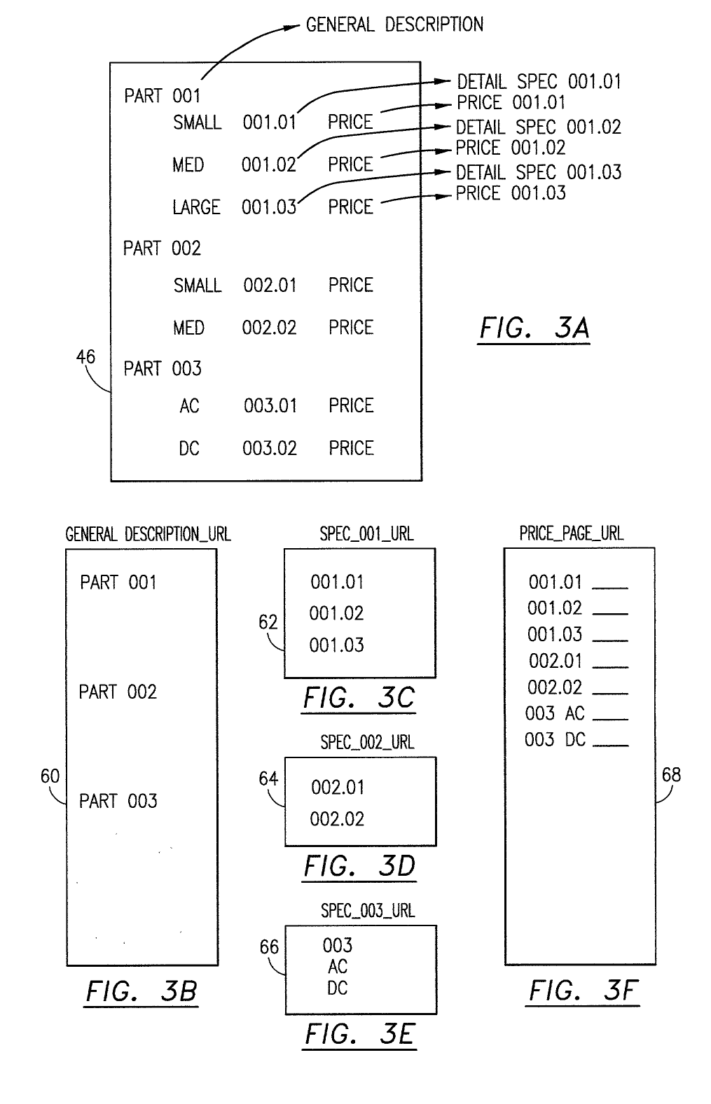

FIG. 3A shows a modified HTML page 46 which has hyperlink pointers from Part 001 to a general description URL, a small Part 001.01 to a detailed specification 001.01 and a price for that small Part 001.01 to a price page or location URL price 001.01. Medium Part 001.02 is actively linked to detailed spec for Part 001.02. Price for that medium part is linked to price page at price 001.02. Large Part 001.03 is linked to detailed spec 001.03. The corresponding price is linked to price page 001.03.

FIG. 3B shows a General Description URL HTML document 60 showing Parts 001,002 and 003. A user clicking on or activating Part 001 in HTML document 46 would be directed to the beginning of the HTML document 60 in FIG. 3B at Part 001. If the user selects, in HTML document 46 in FIG. 3A, Part 002, he or she will be hyperlinked to the General Description URL HTML document 60 and particularly Part 002. If the user clicks on or activates the Part numbers 001.01; 001.02 or 001.03 in HTML document 46 (FIG. 3A), the user is shuttled or transferred to the URL page or document 62 which is the Detailed Spec for Parts 001.01; 001.02 and 001.03. More importantly, the user is directed to the specific location for the specific part in HTML page 62. If the user selects Part 002.01 or 002.02, the user is hyperlinked to HTML page 64 in FIG. 3D the Detailed Spec for Part 002. In a similar manner, the user, upon selection of Part AC 003.01 or the Part DC 003.01 is transferred via hyperlink to the HTML page 66 in FIG. 3E, the detailed specification for Part 003. HTML document 66 may be on a different server compared to HTML document 46.

FIG. 3F shows HTML page or document 68 which is a price list for all the parts. Accordingly, clicking on the “price” link next to or on Part 001.01 transfers the user to HTML page 68 and particularly the price for Part 0.001.01. In contrast, the price for Part 003 AC (see lower right of HTML page 46 in FIG. 3A) is transferred to the bottom of the price HTML page 68 in FIG. 3F. Although part numbers have been discussed herein, any string of letters, terms, words or numbers may be dynamically created as active hyperlink tags.

The present invention could be produced in various hardware or software configurations, or in a combination of hardware and software, and these implementations would be known to one of ordinary skill in the art. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means (such as a local or widely distributed network over a telecommunications system) as would be known by one of ordinary skill in art.

According to the inventive principles as disclosed in connection with the preferred embodiment, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

The claims appended hereto are meant to cover modifications and changes within the spirit and scope of the present invention.

What is claimed is:

1. A method for dynamically creating an HTML document with at least one embedded hyperlink code, said HTML document based upon a source document, the method comprising the steps of:
providing a database which associates location data of a plurality of data strings with hyperlink addresses, said location data mapping at least one predetermined data string of said plurality of data strings in said source document;
publishing an HTML document based upon said source document with an image tag on, at or near said predetermined data string, said image tag including an image tag URL pointing to said database;
obtaining from said image tag URL in said published HTLM document, HTML location data unique to the image tag location in said HTML document;
obtaining from said database a corresponding hyperlink address associated with unique location data correlated to said HTML location data;
publishing and embedding in said HTML document at, on or near said predetermined data string, an active tag with said corresponding hyperlink address therein.

2. A method as claimed in claim 1 wherein said method is implemented in a client-server computer environment, said environment including at least one server computer system and at least one client computer system coupled via telecommunications network to said server computer system, and the steps of providing a database, publishing an HTLM document, obtaining HTML location data from the image tag in said published HTLM document; obtaining said corresponding hyperlink address and publishing and embedding are implemented by said server computer system.

3. A method as claimed in claim 2 including the step of obtaining said image tag URL and said HTLM location data occurs based upon operation of said client computer system.

4. A method as claimed in claim 1 wherein said database associates a plurality of location data for a plurality of data strings with a corresponding plurality of hyperlink addresses; a sub-plurality of location data being mapped with said predetermined data string based upon said source document, and said database correlating substantially each occurrence of said predetermined data string in said source document with a respective location data of said sub-plurality of location data.

5. A method as claimed in claim 1 wherein the step of obtaining from said image tag URL occurs after the step of publishing said HTLM document.

6. A method as claimed in claim 3 wherein the step of obtaining from said image tag URL occurs via said client computer system and after the step of publishing said HTLM document.

7. A method as claimed in claim 1 wherein said hyperlink addresses are generally classified as hyperlinks to HTLM documents providing (a) further details of said predetermined data string, (b) price data for said predetermined data string or (c) an HTML form facilitating purchase of goods or services represented by said predetermined data string.

8. A method as claimed in claim 3 wherein said database associates a plurality of location data for a plurality of data strings with a corresponding plurality of hyperlink addresses; a sub-plurality of location data being mapped with said predetermined data string based upon said source document, and said database correlating substantially each occurrence of said predetermined data string in said source document with a respective location data of said sub-plurality of location data.

9. A method as claimed in claim 8 wherein the step of obtaining from said image tag URL occurs after the step of publishing said HTLM document.

10. A method as claimed in claim 9 wherein said hyperlink addresses are generally classified as hyperlinks to HTLM documents providing (a) further details of said predetermined data string, (b) price data for said predetermined data string or (c) an HTML form facilitating purchase of goods or services represented by said predetermined data string.

11. A method for dynamically creating an HTML document, based upon a source document, with at least one embedded hyperlink code from at least one server computer system to at least one client computer system, said sever system coupled to said client system via a telecommunications network, the method comprising the steps of:
providing a database on said server system which associates location data of a plurality of data strings with hyperlink addresses, said location data mapping at least one predetermined data string of said plurality of data strings in a source document;
publishing an HTML document to said client system based upon said source document with an image tag on, at or near said predetermined data string, said image tag including an image tag URL pointing to said database;
obtaining from said image tag URL in said published HTLM document and from said client system, HTML location data unique to the image tag location in said HTML document;
obtaining from said database a corresponding hyperlink address associated with unique location data correlated to said HTML location data;
publishing to said client system and embedding in said HTML document at, on or near said predetermined data string, an active tag with said corresponding hyperlink address therein.

12. A method as claimed in claim 11 wherein said database associates a plurality of location data for a plurality of data strings with a corresponding plurality of hyperlink addresses; a sub-plurality of location data being mapped with said predetermined data string based upon said source document, and said database correlating substantially each occurrence of said predetermined data string in said source document with a respective location data of said sub-plurality of location data.

13. A method as claimed in claim 11 wherein the step of obtaining from said image tag URL occurs after the step of publishing said HTLM document.

14. A method as claimed in claim 11 wherein said hyperlink addresses are generally classified as hyperlinks to HTLM documents providing (a) further details of said predetermined data string, (b) price data for said predetermined data string or (c) an HTML form facilitating purchase of goods or services represented by said predetermined data string.

15. A method for dynamically creating an HTML document, based upon a source document, with at least one embedded hyperlink code from at least one server computer system to at least one client computer system, said sever system coupled to said client system via a telecommunications network, the server maintaining a database which associates location data of a plurality of data strings with hyperlink addresses, said location data mapping at least one predetermined data string of said plurality of data strings in a source document, the method comprising the steps of:
publishing an HTML document on said client system based upon said source document with an image tag on, at or near said predetermined data string, said image tag including an image tag URL pointing to said database;
generating, from said image tag URL, HTML location data unique to the image tag location in said HTML document;
receiving from said database a corresponding hyperlink address associated with unique location data correlated to said HTML location data;
publishing and embedding in said HTML document at, on or near said predetermined data string, an active tag with said corresponding hyperlink address therein.

16. A method as claimed in claim 15 wherein said database associates a plurality of location data for a plurality of data strings with a corresponding plurality of hyperlink addresses; a sub-plurality of location data being mapped with said predetermined data string based upon said source document, and said database correlating substantially each occurrence of said predetermined data string in said source document with a respective location data of said sub-plurality of location data.

17. A method as claimed in claim 15 wherein the step of generating HTML location data occurs after the step of publishing said HTLM document.

18. A method as claimed in claim 17 wherein said hyperlink addresses are generally classified as hyperlinks to HTLM documents providing (a) further details of said predetermined data string, (b) price data for said predetermined data string or (c) an HTML form facilitating purchase of goods or services represented by said predetermined data string and the method includes the step of linking said client system to one of said classified hyperlinks.

19. An information processing system dynamically creating an HTML document with at least one embedded hyperlink code, said HTML document based upon a source document, comprising:
a database which associates location data of a plurality of data strings with hyperlink addresses, said location data mapping at least one predetermined data string of said plurality of data strings in said source document;
an HTML document based upon said source document with an image tag on, at or near said predetermined data string, said image tag including an image tag URL pointing to said database;
means for obtaining from said image tag URL in said published HTLM document, HTML location data unique to the image tag location in said HTML document and for obtaining from said database a corresponding hyperlink address associated with unique location data correlated to said HTML location data; and
means for modifying said HTML document at, on or near said predetermined data string, by embedding an active tag with said corresponding hyperlink address therein.

20. A processing system as claimed in claim 19 wherein said database associates a plurality of location data for a plurality of data strings with a corresponding plurality of hyperlink addresses; a sub-plurality of location data being mapped with said predetermined data string based upon said source document, and said database correlating substantially each occurrence of said predetermined data string in said source document with a respective location data of said sub-plurality of location data.

21. A processing system as claimed in claim 19 wherein said hyperlink, addresses are generally classified as hyperlinks to HTLM documents providing (a) further details of said predetermined data string, (b) price data for said predetermined data string or (c) an HTML form facilitating purchase of goods or services represented by said predetermined data string and the method includes the step of linking said client system to one of said classified hyperlinks and the system includes one HTLM document from the group of HTML documents which include (a) include said further details; (b) price data; and (c) a system for facilitating said purchase.
